(19) United States
(12) Patent Application Publication
(10) Pub. No.: US 2007/0025416 A1
(43) Pub. Date: Feb. 1, 2007

(54) Clinical thermometer

(76) Inventor: Hui-Ming Chen, Chang Hua Sien (TW)

Correspondence Address: LEONG C LEI, PMB # 1008, 1867 YGNACIO VALLEY ROAD, WALNUT CREEK, CA, 94598, US

(21) Appl. No.: 11/189,712

(22) Filed: Jul. 27, 2005

(51) Int. Cl. G01K 7/00

(52) U.S. Cl. 374/163

(57) ABSTRACT

A clinical thermometer is disclosed. The thermometer comprises a housing, circuit board, base seat, humming plate and spring characterized in that the base seat has a speaker box slot and a speaker cover plate with the humming plate mounted therein, circuit connection is formed between the humming plate and the circuit board by the spring, and the length of the base seat is shorter than the circuit board such that the electronic components which are required to be inspected are exposed outside the base seat, thereby minimizing the inspection time and replacement time of the components.

### BACKGROUND OF THE INVENTION

(a) Technical Field of the Invention

The present invention relates to clinical thermometer, and in particular, an electronic thermometer which facilitates the inspection and replacement of components within the housing of the thermometer.

(b) Description of the Prior Art

Taiwanese Patent Publication No. 3988627 entitled “Electronic Clinical Thermometer” discloses a clinical thermometer with improved housing. The drawback of having to mount a contact spring has not been dealt with. The contact spring 300 and the base seat 100 are made from different materials; therefore the mounting of the spring onto the base seat has to be made manually. Accordingly, the cost of labour is increased. In this conventional electronic clinical thermometer, if the thermometer that is undergone inspection is below standard, the circuit board has to withdraw and electronic components 400 on the board needs to be either maintained or replaced. The withdrawal of the circuit board may damage the board. Accordingly, it is an object of the present invention to provide a clinical thermometer, which allows convenient inspection and reduces the cost of production.

### SUMMARY OF THE INVENTION

The primary purpose of the present invention is to provide a clinical thermometer having a housing, circuit board, base seat, humming plate and spring characterized in that the base seat has a speaker box slot and a speaker cover plate with the humming plate mounted therein, circuit connection is formed between the humming plate and the circuit board by the spring, and the length of the base seat is shorter than the circuit board such that the electronic components which are required to be inspected are exposed outside the base seat, thereby minimizing the inspection time and replacement time of the components.

Yet still a further object of the present invention to provide a clinical thermometer, wherein the speaker box containing the humming plate enhances clarity and consonance effect of sound wave generated by the humming plate.

A further object of the present invention is to provide a clinical thermometer, which allows simple fabrication process and increases working efficiency and yield, thus the cost of production is lowered.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows an exploded perspective view of a conventional clinical thermometer.

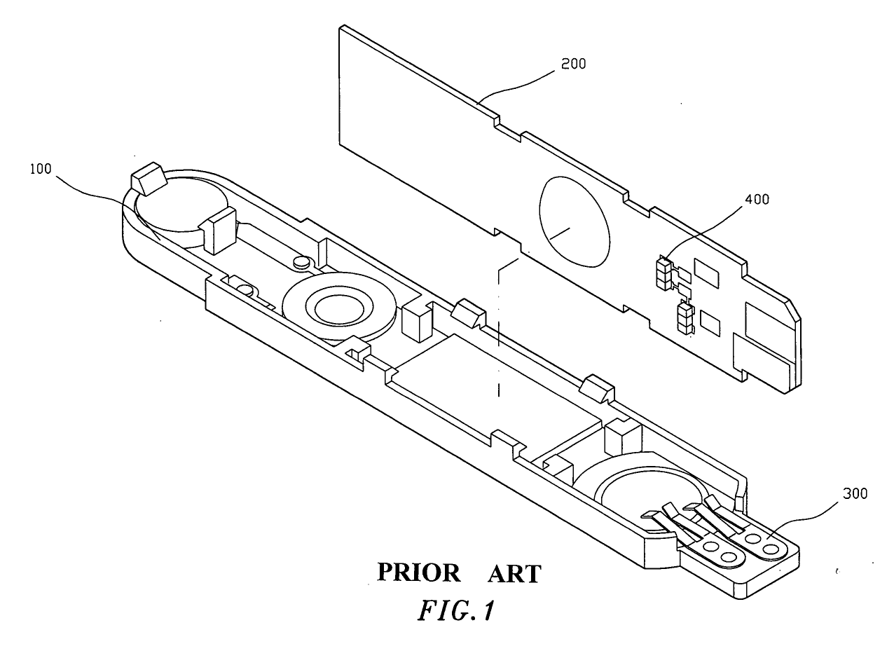

FIG. 2 is a schematic view of, showing the internal structure of a clinical thermometer of the present invention.

FIG. 3 is a perspective exploded view of the clinical thermometer of the present invention.

FIG. 4 is a perspective view, showing the internal structure of the clinical thermometer in accordance with the present invention.

FIG. 5 is a sectional view of the clinical thermometer in accordance with the present invention.

FIG. 6 is a perspective view of the internal component of the clinical thermometer in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

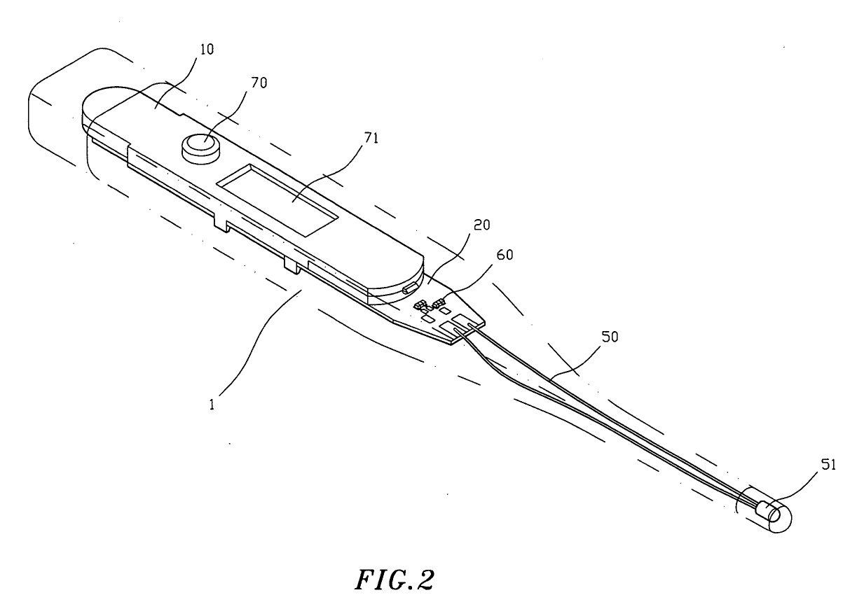

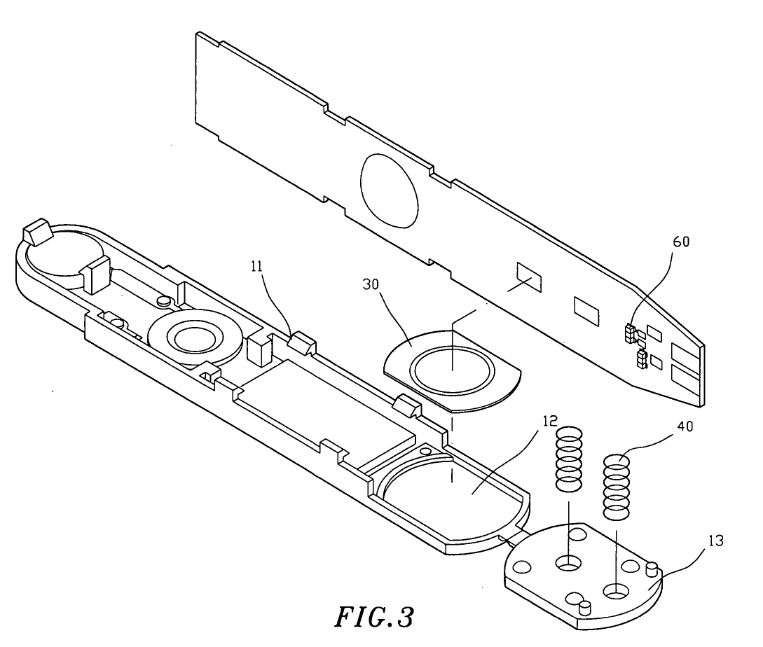

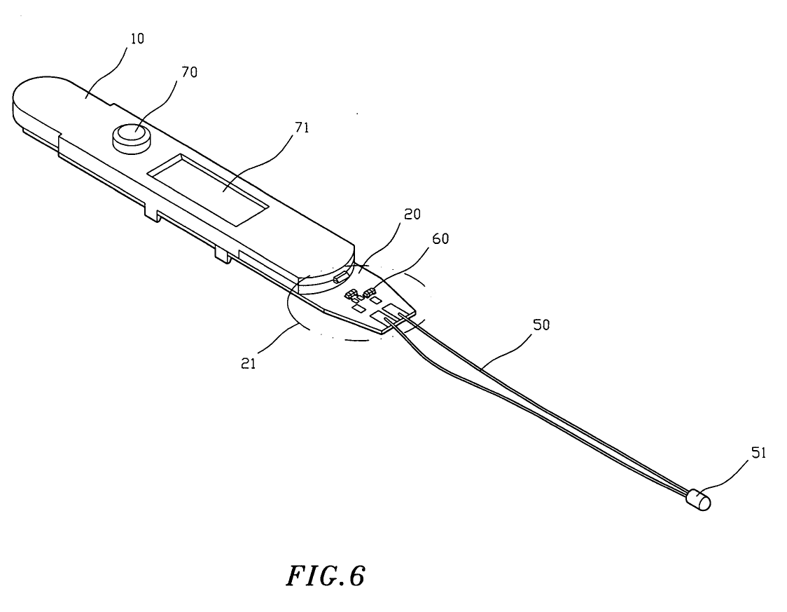

Referring to FIGS. 2 to 6, there is shown an improved structure of a clinical thermometer, comprising a housing 1, a base seat 10, a single face circuit board 20, a humming plate 30, and spring 40.

In accordance with the present invention, the base seat 10 is provided with a speaker box slot 12 containing the humming plate 20. The slot 12 is covered using a speaker box cover plate 13 forming into a speaker specifically for the humming plate 20. The two lateral sides of the base seat 10 are provided with a buttoning plate 11 to firmly fasten the single face circuit board 20. By means of the spring 40, passing through the loudspeaker cover plate and the single face circuit board, the humming plate 30 is connected to form an electronic loop. At this instance, the spring 40 is the conducting for power supply of the humming plate 30 and the single plate circuit board 20.

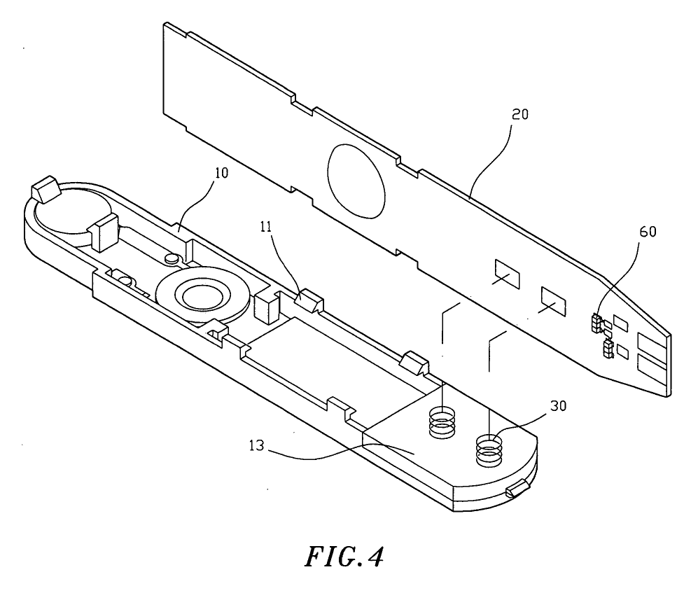

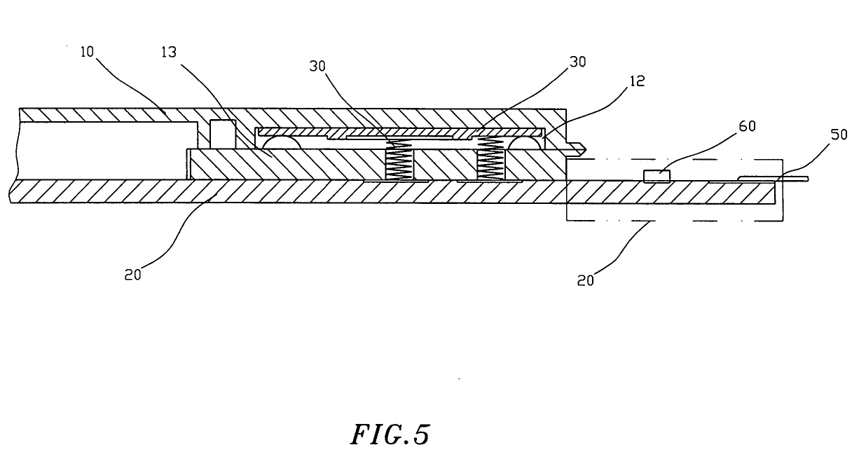

As shown in FIGS. 4 and 5, the size of the base seat 10 is reduced such that after the base seat 10 and the single face circuit board 20 are fastened, the base seat 10 does not have equal size, and the electronic components 60 on the single face circuit board 20 will be exposed outside the base seat 10. In the manufacturing process of clinical thermometer, detailed inspection of the thermometer is required. If the measurement of the temperature sensing section 51 does not meet the standard temperature calibration, the clinical thermometer needs to be maintained or the electronic component needs to be replaced 60. At this instance, the base seat 10 is reduced such that the electronic components 60 are exposed at the outer side of the base seat 10. Thus, in the course of inspection, the unloading of the circuit board 20 is not required. The circuit board 20 has a temperature sensing connection end 50 and a conducting wire connects the connection end 50 to the temperature sensing section 501 so as to measure temperature.

In application, the start button 70 is depressed, the sensing portion 51 at the front end of the clinical thermometer senses the body temperature which is displayed via the LCD 71 showing the temperature of the body. If the clinical thermometer measured the temperature of the human body based on the principle of heat balance. At this instance, the frequency of the CPU, and the output alarming signal is about 5 KHz, 8 KHz via humming plate 30 which generates mono sound, and the clarity and resonance of the sound are enhanced by the speaker and this will alert the person taking the body temperature. If the temperature is abnormal, treatment has to be taken.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A clinical thermometer having a housing, circuit board, base seat, humming plate and spring characterized in that
the base seat has a speaker box slot and a speaker cover plate with the humming plate mounted therein, circuit connection is formed between the humming plate and the circuit board by the spring, and the length of the base seat is shorter than the circuit board such that the electronic components which are required to be inspected are exposed outside the base seat, thereby minimizing the inspection time and replacement time of the components.

2. The clinical thermometer of claim 1, wherein the speaker box containing the humming plate enhances clarity and consonance effect of sound wave generated by the humming plate.
